(19) United States
(12) Patent Application Publication
(10) Pub. No.: US 2010/0192532 A1
(43) Pub. Date: Aug. 5, 2010

(54) Variable Speed Transamission

(76) Inventors: Tom Joseph Slater, Sheffield (GB); John Coleman, Sheffield (GB)

Correspondence Address: MESCHKOW & GRESHAM, P.L.C., 7250 NORTH SIXTEENTH STREET, SUITE 318, PHOENIX, AZ, 85020-5279, US

(21) Appl. No.: 12/362,747

(22) Filed: Jan. 30, 2009

(51) Int. Cl. A01D 69/00; A01D 69/06; A01D 69/08; F16H 37/06

(52) U.S. Cl. 56/11.5; 56/11.4; 56/11.1; 74/665 F

(57) ABSTRACT

A grass treatment device is provided, which comprises a motor configured to provide a power, a grass treatment tool configured to interact with and treat a grass surface, a drive mechanism configured to propel the device relative to the grass surface and a transmission operably positioned between the motor, the tool and the drive mechanism. The transmission is configured to transmit power from the motor independently to the tool and to the drive mechanism. The transmission is further configured to transform a constant output from the motor into independent variable powering of the tool and the drive mechanism.

### FIELD OF THE INVENTION

The present invention relates to a new type of transmission for a turf or grass treatment apparatus such as a mower, the transmission comprises a variable speed gearbox with at least two gear ratios.

### BACKGROUND TO THE INVENTION

Traditional hand operated grass treatment devices such as mowers or greensrollers comprise a transmission or gearbox with a single gear ratio as the treatment mechanism of the device, which is driven by the gearbox, is fixed and therefore a single gear ratio is sufficient to provide a preset speed or number of revolutions per minute to the connected tool. The motor also generally drives the device forward by powering wheel or other structures and likewise generally only a single speed is required to ensure, as far as possible, a uniform treatment regime.

An example of such a prior art grass treatment device is disclosed in U.S. Pat. No. 6,200,066 (B1), wherein a self-propelled vibratory greensroller is provided for smoothing a green, improving ball roll distance and striping. The greensroller has a vibratory roller and a power roller mounted in a frame with the vibratory roller in front of and parallel to the power roller. A prime mover mounted on the frame has a gear box with two power-take offs for connection to first and second power trains. The first power train includes a centrifugal clutch, which starts the vibratory roller into vibration at some preselected engine speed. The second power train includes a variable speed pulley, which provides infinite ground speed control for the power roller.

Another example of such a prior art grass treatment device is disclosed in GB 1237643 (A), wherein a two-speed chain and sprocket gearbox is provided for driving the roller of a power-operated lawn-mower. The chain and sprocket gearbox comprises an electric or I.C. engine driven shaft, which drives through a spring-engaged, manually-released dog clutch to a gear input shaft, on which first and second sprockets are mounted freely and via a one-way sprag clutch respectively. The sprockets are connected via chains to a lay-shaft, which is in turn connected to the roller via two further sprockets and a chain. In first (low) speed, the input shaft drives through the one-way clutch to the first sprocket driving the roller via chains, the second sprocket rotating freely on the shaft. In second (high) speed, provided by axially sliding the second sprocket into engagement with a dog-clutch peg on the input via a manual gear selector and lever arm, the second sprocket drives the roller via chains, the first sprocket overrunning on the one-way sprag clutch.

The most important consideration and driving factor behind the work of the greens keeper is to, insofar as possible, ensure uniformity between all the different greens of a given golf course. Most normally greens are measured using the distance a golf ball travels across the green when it is hit with a pre-determined quantity of force. The actual distance the ball travels on a particular green is not something which green keepers seek to set at a particular level, a more important consideration is that all the different greens on a given course have, as far as possible, identical properties.

Various tools exist to allow the greens keeper to alter the properties of a particular green or other turf surface. A normal approach a greens keeper could take is to add or remove material from a green using a variety of different mechanical means and introducing or attempting to remove various different materials. For instance, often greens keeper will introduce sand into the green in order to lighten the underlying soil in which the turf rests.

This can be facilitated after the application of sand to a surface using a vibratory roller which, through vibrations as its name suggests, causes sand placed upon the surface of a green to fall through the shoots of the green onto and into the soil surface.

Alternatively, the mechanical manipulation of the green may also be effected using, for instance, a groomer, which comprises a number of substantially rigid and parallel blades that are perpendicular to the shaft in which they rest and about which they turn. The interaction of such a groomer with a grass surface can physically mix the existing structure of the soil with any material placed on top of it, for instance, sand, fertiliser or other organic or inorganic materials.

At the present time, most prior art devices to assist the greens keeper in such tasks are limited to a specific type of treatment tool associated with a specific device. Further, generally speaking the tool is also configured to move at a set rate which can not be varied by a user, for instance the vibratory roller disclosed in U.S. Pat. No. 6,200,066 (B1). Therefore, if different treatment regimes are required upon different greens or other areas of the golf course, it is often necessary for a greens keeper to employ several devices, each of which is used to effect one or more treatment regimes on different portions of the golf course. This can result is significant costs, as each of these machines needs to be maintained in good working order even though it may only be used to treat a single or a small number of greens at unpredictable intervals over its operating lifetime. A limited number of prior art devices feature a system of interchangeable treatment tools, which only partially overcomes the above problem, because the speed of rotation of the tools is not configurable in these devices, whereby their effctiveness is limited.

In addition, it is also possible that, in order to achieve a specific treatment regime for a grass surface, a user may wish to use a single type of treatment tool but at different speed or rates of revolution settings due to the specific conditions present at the various sites around the golf course. With prior art grass treatment devices, this would require a number of grass treatment tools each with an identical treatment head but with different gearing, so as to perform the same treatment according to the different rates and thereby achieve different types of treatment.

It is possible with some prior art devices to, by misusing the device, cause the treatment head to move at different rates. Prior art devices are not generally configured to allow this, and the results can be variable. Great damage can be caused to turf surfaces from the misuse of such prior art equipment. In particular, if a user is not skilled enough to operate the grass treatment apparatus outside of its normal operating parameters, it is still immensely difficult to instigate a specific and constant treatment regime on a number of different portions of the golf course using such an inaccurate way of adapting the treatment characteristics of such prior art treatment devices.

The inventors, seeing the disadvantages associated with prior art grass treatment devices and, in particular, the need for several independent grass treatment devices to perform related but different treatment operations, have derived a new solution to these problems.

### SUMMARY OF THE INVENTION

The inventors have sought to provide a grass treatment device, which is capable of producing a different treatment effect using a single treatment head by powering this treatment head at variable numbers of revolutions per minute and torque levels, and also by providing a single piece of apparatus for use with various treatment heads, each of which requires powering at different levels due to the different geometry and other characteristics thereof.

The inventors have developed an interchangeable system allowing the replacement of one grass treatment tool with another with ease, wherein a first gear ratio may be unsuitable for both types of tools, as the circumference of surface-engaging components in these tools may vary significantly in some cases. Therefore, the inventors have also sought to provide a variable speed transmission suitable for use with a grass or turf treating apparatus.

Further, the inventors have sought to provide a propelled grass treatment device, wherein the variable speed transmission can further power device motion means of the propelled grass treatment device at variable numbers of revolutions per minute and torque levels.

According to a first aspect of the present invention there is provided a grass treatment device, comprising:
a motor configured to provide a power;
a grass treatment tool configured to interact with and treat a grass surface;
a drive mechanism configured to propel the device relative to the grass surface;
a transmission operably positioned between the motor, the tool and the drive mechanism, configured to transmit power from the motor independently to the tool and to the drive mechanism;
wherein the transmission is further configured to transform a constant output from the motor into independent variable powering of the tool and the drive mechanism.

Preferably the drive mechanism configured to propel the treatment device is powered by a different output shaft to that operably connected to the grass treatment tool.

Preferably the drive mechanism configured to propel the treatment device and the grass treatment tool are powered by different transmission ratios. Alternatively the drive mechanism configured to propel the treatment device and the grass treatment tool are powered by the same gear box ratios.

Preferably the transmission is capable of providing a continuously variable output. The transmission may comprise a continuously variable transmission. Alternatively, the transmission may comprise an infinitely variable transmission.

Preferably the transmission is capable of powering the grass treatment tool at a plurality of speed settings. Preferably the transmission comprises a speed selector mechanism.

Preferably the grass treatment device comprises a cassette system configured to allow the introduction and removal of a plurality of various grass treatment tools, each of which is configured to be operably connected to the transmission.

Preferably the grass treatment tool is one selected from the group comprising a vibratory roller; a thatchmaster; an ultra grooma; a scarifier; a sarel roller cassette; a star spiker; a rotary brush and a true level vibratory roller brush.

Preferably, the cassette system comprises a first and a second roller configured to contact a grass surface, wherein the treatment tool is positioned between the first and the second roller.

Preferably the motor comprises an electrical motor. Alternatively, the motor comprises an internal combustion motor.

Preferably the grass treatment device is selected from the group comprising two-wheeled, four-wheeled and tracked devices.

Preferably the grass treatment device is selected from the group comprising devices requiring the user to stand in close proximity thereto, devices requiring the user to sit thereon and remote—controlled devices.

According to a second aspect of the present invention there is provided a transmission suitable for use with a hand operated grass treatment device, the device comprising:
a motor configured to provide power;
a grass treatment tool configured to interact with and treat a grass surface;
a drive mechanism configured to propel the device relative to the grass surface; and
the transmission;
wherein the transmission is operably positioned between the motor, the tool and the drive mechanism, and is configured to transmit power from the motor independently to the tool and to the drive mechanism; and
wherein the transmission is further configured to transform a constant output from the motor into independent variable powering of the tool and the drive mechanism.

According to a third aspect of the present invention, there is provided a kit of parts for a grass treatment device, comprising:
a motor configured to provide power;
a grass treatment tool configured to interact with and treat a grass surface;
a drive mechanism configured to propel the device relative to the grass surface; and
a transmission operably positioned between the motor, the tool and the drive mechanism, configured to transmit power from the motor independently to the tool and to the drive mechanism;
wherein the transmission is further configured to transform a constant output from the motor into independent variable powering of the tool and the drive mechanism.

According to a fourth aspect of the present invention, there is provided a method of independently powering a drive mechanism and a grass treatment tool of a grass treatment device, the method comprising the steps of:
providing the device with the grass treatment tool, the drive mechanism and a motor;
providing the device with a transmission operably positioned between the motor, the tool and the drive mechanism, wherein the transmission is configured to transform a constant output from the motor into independent variable powering of the tool and the drive mechanism; and
transmitting power from the motor independently to the tool and to the drive mechanism through the transmission.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 provides a perspective view of a right side of a grass treatment device according to a first embodiment of the present invention, including a variable transmission having a first linkage arrangement.

FIG. 2 provides a perspective view of a left side of the grass treatment device of FIG. 1, including the variable transmission having a second linkage arrangement.

FIG. 3 provides a perspective view of the variable transmission of FIGS. 1 and 2, in isolation of the grass treatment device, and including ratio selection levers.

FIG. 4 provides a side elevation of the ratio selection lever of FIG. 3 connected to the first linkage arrangement of FIG. 1.

FIG. 5 provides a side elevation of the ratio selection lever of FIG. 3 connected to the second linkage arrangement of FIG. 2.

FIG. 6 provides a side elevation of the ratio selection lever of FIG. 3 connected to a linkage arrangement according to another embodiment.

FIG. 7 provides a perspective view of two linkage arrangements such as that show in FIG. 6, in isolation of the transmission, one in respect of each of the tool speed gear ratio and the device motion gear ratio.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

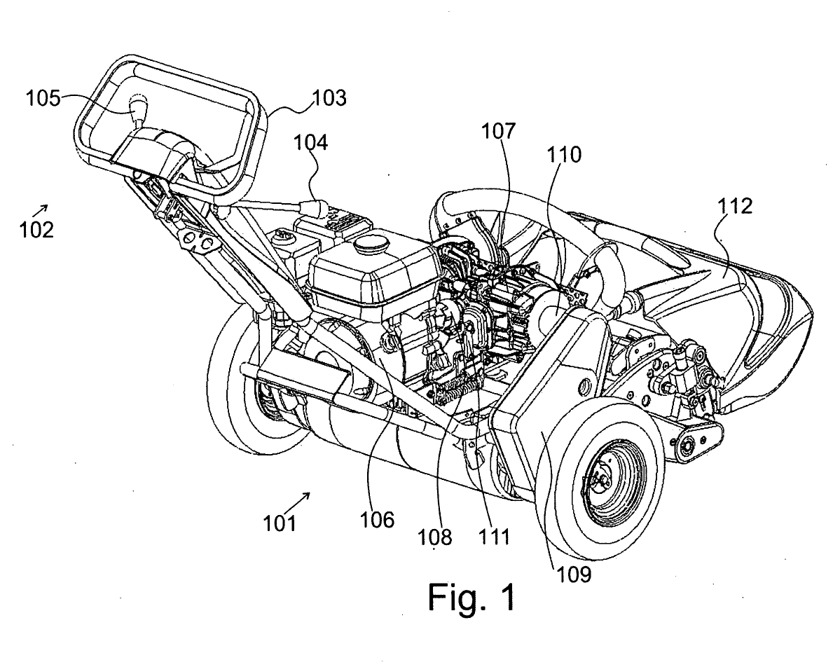

In accordance with a first specific embodiment of the present invention and with reference to FIG. 1 herein, there is shown a right perspective view of a grass treatment device 101, in the example a hand mower. This hand mower is configured to interact with and treat a grass surface over which it travels, by way of a number of different grass treatment tools which it may carry and power. It will be readily understood by the skilled person that the principles of the present invention are not limited to the example hand mower, and that the present invention is equally capable of implementation in any other type of propelled grass treatment device, whether it be two-wheeled, four-wheeled or tracked, and whether it be of the type requiring the user to stand in close proximity thereto, requiring the user to sit thereon, or remote—controlled.

The hand mower 101 comprises several distinct components, or sections. A first component is a user interface 102 for operating the hand mower, specifically to direct the other components of the hand mower in a required direction and/or at a required speed. The user interface comprises device steering means 103, device speed control means 104 and tool speed control means 105, which allow the user of the hand mower 101 to comprehensively control operation of the hand mower.

Further components of the hand mower comprise a power unit or motor 106, a transmission or gear box 107 which is coupled with the power unit or motor 106 at an input portion 108 thereof, and a drive mechanism 109 to propel the mower 101, which is coupled with the transmission 107 at a first output portion 110 thereof. Transmission 107 and device speed control means 104 are connected to one another by a first linkage arrangement 111, which will be further detailed hereinafter.

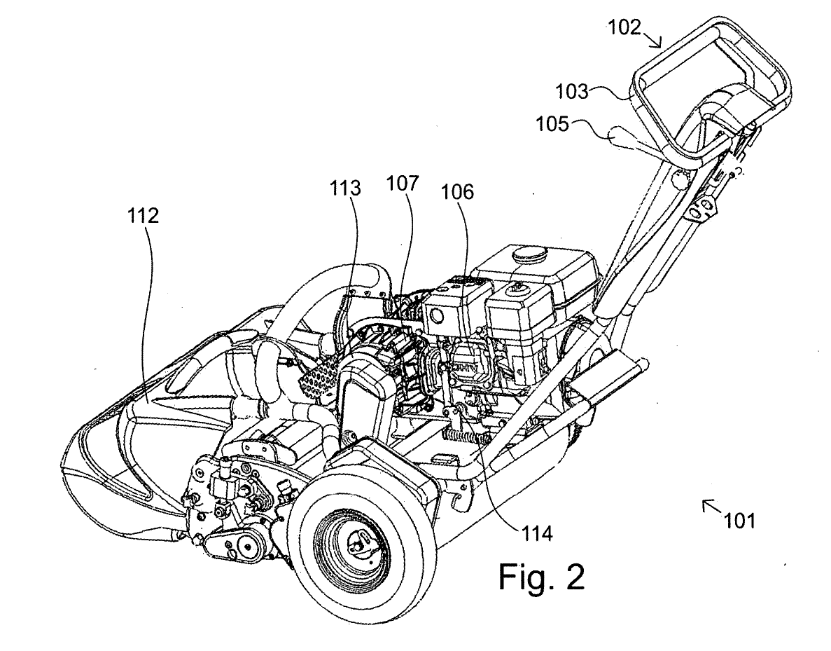

With reference to FIG. 2 herein there is shown a left perspective view of the grass treatment device 101 of FIG. 1, wherein the transmission or gear box 107 is coupled with the power unit or motor 106 at the input portion 108 thereof, and a further component of the hand mower comprises a grass treatment head 112 housing a grass treatment tool (not shown), wherein the grass treatment tool is coupled with the transmission 107 at a second output portion 113 thereof. Transmission 107 and tool speed control means 105 are connected to one another by a second linkage arrangement 114, which will be further detailed hereinafter.

The treatment head 112 may comprise a cassette system, which permits the introduction and removal of a plurality of various grass treatment tools, each of which is configured to be operably connected to the transmission 107 at the second output portion 113 thereof. Such a cassette system may comprise first and a second rollers (not shown) configured to contact the grass surface over which hand mower 101 travels, wherein the grass treatment tool is positioned in a space located between the first and the second rollers, whereby the rollers ably position the treatment tool such that it can interact with e grass surface and perform the necessary treatment tasks. Many different grass treatment tools may be used by green keepers for maintaining turf surfaces, including:
the vertical cutter tool, which is used to prevent thatch accumulation and cut through stolons and rhizomes in fine turf. Regular use of the vertical cutter tool will improve surface texture especially when used in conjunction with light top-dressing. The Tungsten tipped blades are spaced at 10 mm centers.
the ultra groomer tool, which has 90 tungsten carbide tipped blades spaced 5 mm apart, this tool ensures greens turf is maintained in the best possible conditions. It helps minimise puffiness in both high density creeping bent and Bermuda grass and removes unsightly seed heads in Poa annua turf with minimal treatment. On newly established greens, it can help reduce the ingress of Poa annua by uprooting individual Poa plants before they get a chance to take hold.
the scarifier tool, for greens that already have thatch at depth. The Scarifier tool includes a plurality of super tough blades spaced at 45 mm apart, spaced apart by brush spacers which ensure a hygienic clean-up and effective throwing of the removed thatch into the grass catchers.
the sarel roller tool, for continual rolling whilst cutting, the airborne silt generated therewith creating surface sealing on fine turf. This can lead to decreased infiltration rates and a reduction in gas exchange between the atmosphere and the root zone upper horizon. Regular use of the sarel roller tool prevents surface sealing with minimal surface disruption.
the star spiker tool, which is an alternative method of reducing surface sealing, but uses the same principles as the sarel roller.
the rotary brush tool, the formation of which ensures that the collection of debris is focused into the middle of the grass catcher, thereby maximising the available volume. The bristles are made from high quality nylon resulting in a durable brush with “flex memory”, with a plurality of different bristle stiffness grades.
the true level vibratory roller brush tool, which permits the efficient integration of sand top-dressing deep into the turf canopy. Even if the top-dressing sand is damp, integration can be assisted by brushing and vibratory rolling simultaneously. The Vibro Brush can also be used without vibration, by switching off the drive to the Vibro Roller, thereby truning it into a static brush.

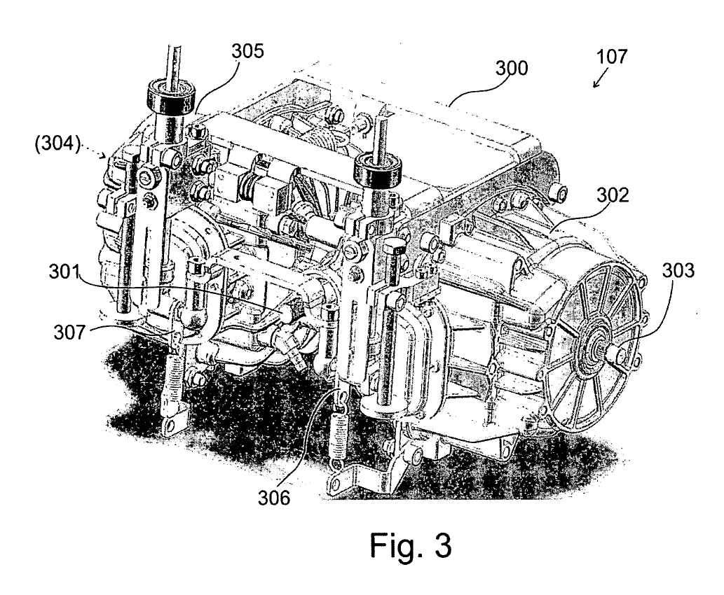

With reference to FIG. 3 herein, there is shown a perspective view of a casing 300, which encloses the variable transmission or gear box suitable for use as a component 107 of the grass treatment device 101 previously described, having a single power input portion 108 and two independent output portions 110, 113.

In the preferred embodiment of the present invention, transmission 107 is capable of providing a continuously variable output, by changing through an infinitive number of effective gear ratios between minimum and maximum values.

In a specific embodiment of the present invention, transmission 107 is a continuously variable transmission (CVT). A CVT is a transmission in which the ratio of the rotational speeds of two shafts, such as the input shaft and output shaft of a vehicle or other machine, can be varied continuously within a given range, providing an infinite number of possible ratios. The CVT comprises a plurality of arrangements of discs and rollers transmitting power between the discs, wherein the power input shaft 301 at power input portion 108 receives power from motor 106 and is operably connected to two respective arrangements of discs and rollers, which are symmetrically disposed left and right relative to the input shaft 301.

The transmission comprises an input sprocket, located on the end of the input shaft 301. This input sprocket is operably connected to a differential. Projecting from opposite edges of this differential are respective transverse shafts. On a first side 302 of the transmission, power input shaft 301 is therefore operably connected to a first transverse shaft. The transverse shaft bears a disc tapering into a cone away from the input shaft 301, wherein the longitudinal axis of the cone is coaxial with the transverse shaft and the disc is centrally mounted on the shaft. First power output shaft 303 at output portion 110 is co-axial with the transverse shaft and bears a second disc tapering into a cone towards the input shaft 301, wherein the longitudinal axis of the cone is coaxial with the first power output shaft 303 and the second disc is centrally mounted on the shaft. The first and second discs may be substantially similar to one another and horizontally opposed to one another. First power output shaft 303 may hereinafter be referred to as drive output shaft 303.

In this arrangement, the first disc is equivalent to the driving pulley of a conventional belt transmission and the second disc is equivalent to the driven pulley thereof. Rollers or wheels are located between the discs and transmit power from one disc to the other, being equivalent to the belt in the aforementioned conventional belt transmission. The wheels can rotate along two axes, they spin on an horizontal axis and tilt in or out around a vertical axis, wherein the horizontal axis is substantially co-planar with the transverse shaft and the first power output shaft 303, and the vertical axis is substantially perpendicular to the input and output shafts 301, 303. This arrangement allows the wheels to contact the discs in different areas: when the wheels contact the first (driving) disc nearer the apex of the cone, they contact the second (driven) disc nearer the rim thereof, resulting in a reduction in speed and an increase in torque of the driven disc. Alternatively, when the wheels contact the first (driving) disc nearer the rim thereof, they then contact the second (driven) disc nearer the center thereof, resulting in an increase in speed and a decrease in torque. Therefore, tilting of the rollers or wheels seamlessly changes the gear ratio of the transmission between the first and second discs, occasioning smooth and substantially instantaneous ratio changes.

The above arrangement constitutes a first respective arrangement of discs and rollers, of the two arrangements symmetrically disposed left and right relative to the input shaft 301, and it is suitable for transmitting power from motor 106 to first power output shaft 303, in turn powering the drive mechanism 109.

A substantially identical arrangement of discs and rollers constitutes the second respective arrangement of discs and rollers of transmission 107, for independently transmitting power from input shaft 301 to second output shaft 304 (hidden from view in FIG. 3) at output portion 113, in order to power the grass treatment tool located in head 112.

Therefore, on a second side 305 of the transmission, power input shaft 301 is operably connected to a second transverse shaft, for instance by way of the differential mechanism discussed above, which likewise bears a disc tapering into a cone away from the input shaft 301, wherein the longitudinal axis of the cone is coaxial with the transverse shaft and the disc is centrally mounted on the shaft. Second power output shaft 304 is co-axial with the second transverse shaft and bears a further disc tapering into a cone towards the input shaft 301, wherein the longitudinal axis of the cone is coaxial with the first power output shaft 110 and the second disc is centrally mounted on the shaft. Again, rollers or wheels are located between the discs and transmit power from one disc to the other, being equivalent to the belt in the aforementioned conventional belt transmission. The wheels again can rotate along two axes, they spin on an horizontal axis and tilt in or out around a vertical axis, wherein the horizontal axis is substantially co-planar with the transverse shaft and the second power output shaft 304, and the vertical axis is substantially perpendicular to the input and output shafts 301, 304. Therefore, tilting of the rollers or wheels seamlessly changes the gear ratio of the transmission between the first and second discs, occasioning smooth and substantially instantaneous ratio changes for powering second power output shaft 304, independently of the first arrangement powering first power output shaft 303.

In a further specific embodiment of the present invention, transmission 107 comprises a specific type of continuously variable transmission (CVT), the infinitely variable transmission (IVT). In this specific embodiment, the range of ratios of the speed of output shafts 303, 304 to the speed of input shaft 301 includes a zero ratio, i.e. a zero output shaft speed with a defined input speed. This transmission type is achieved by combining the continuously variable transmission detailed above with a planetary gear system, also known as an epicyclic gear system, wherein the gear system effectively translates the difference between two speeds within the IVT transmission (for instance the speed of the power input shaft 301 receiving power from the engine 106 and the speed of the first power output shaft 303) into the actual output shaft rotation speed. The present description does not purport to provide a comprehensive explanation of continuously variable transmissions and infinitely variable transmissions, which is beyond the scope of the present description and is not required for understanding the present invention.

In the preferred embodiment, and with reference to FIGS. 1 to 3, the transmission 107 is therefore operably positioned between the motor 106, the drive mechanism 109 and the grass treatment tool 112, and is configured to transmit power from the motor 106 input via input shaft 301 independently to the tool via output shaft 304 and to the drive mechanism via output shaft 303. The power output from the motor 106 to input shaft 301 is constant, however the independent control of the two discs and rollers arrangements respectively on either side 302, 305 of transmission 107 permits a selection of gear ratio for the grass treatment tool and the drive mechanism independently of one another.

Independent transmission arrangements represent an important advantage of the invention, because the combination of the device speed with the tool RPM and torque levels define in part the treatment effected by a specific tool unto the grass surface: the same tool rotating at a constant rate affects a grass surface differently if it is traveling at 3 miles per hour, rather than 5 miles per hour. Likewise, given a device traveling at a constant speed, the tool affects a grass surface differently if it rotates at 1500 rpm, rather than 2500 rpm. By providing devices in which the drive means and the grass treatment means can be operated at different respective speed, the functionality and versatility of the device is improved.

In order to vary the transmission ratios, the transmission further comprises CVT ratio selection levers 306, 307, which are respectively configured to modulate the activity of the CVT discs in the two arrangements of the transmission for modifying the operation of either the drive mechanism driven by the drive output shaft 303, or the grass treatment tool driven by the cutter output shaft 304, or both. Each of ratio selection levers 306, 307 is connected to the user interface 102 via a respective linkage arrangement 111, 114.

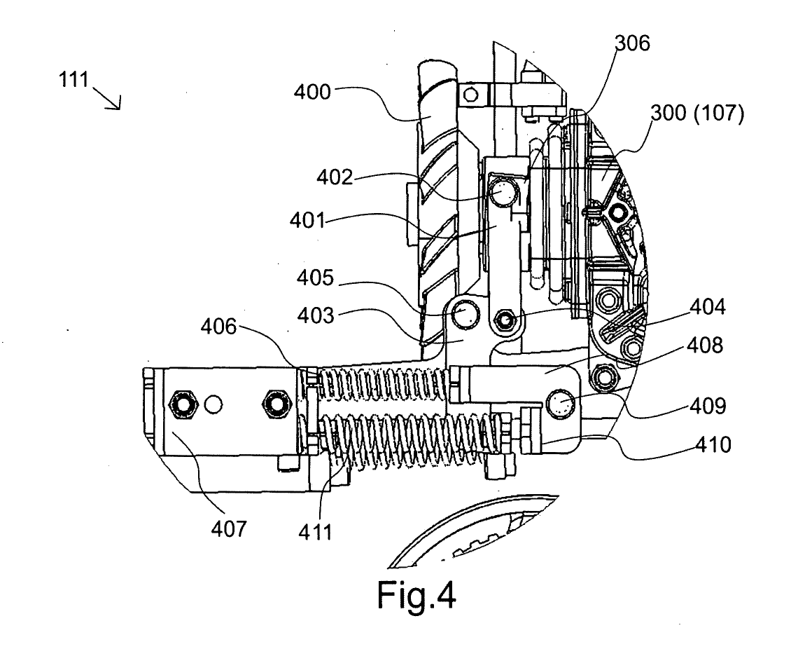

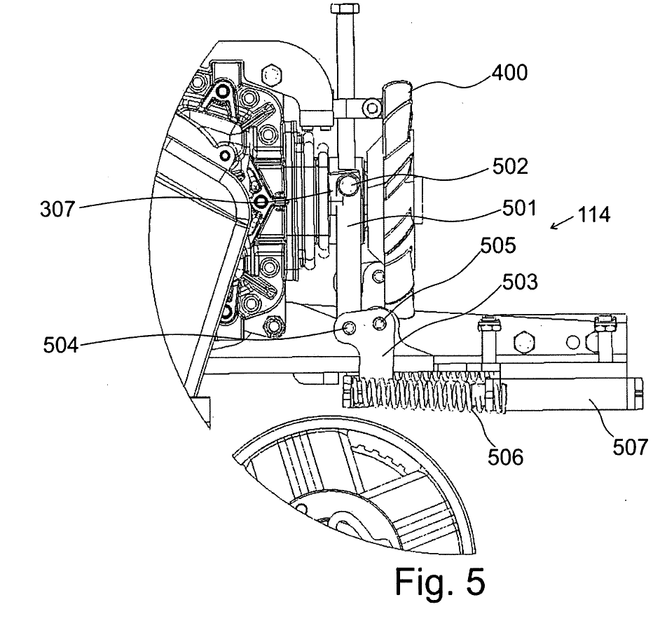

With reference to FIG. 4, a first embodiment of the first linkage arrangement 111 is shown, wherein the ratio selection lever 306 is pivotally connected to a device motion control link 401 at a first end 402 thereof, and wherein a second end 404 of device motion control link 401 is pivotally connected to a device motion control arm 403. In FIGS. 4 and 5, the engine has been removed for purposes of clarity, and would engage power input shaft 301 by way of a clutch, only a first plate 400 of which is shown. The clutch may for instance be a centrifugal clutch, configured to engage shaft 301 once a set amount of rotations per minute is reached.

Device motion control arm 403 is pivoted by a first motion control pivot 405 mounted to a portion of the transmission casing 300, proximal the motion control link end 404 at which it is pivotally connected to device motion control link 401, whereby device motion control arm 403 may pivot relative to motion control pivot 405 independently of its pivotal connection to device motion control link 401. This configuration permits a longitudinal displacement of motion control link 401, relative to the pivoted first and second ends 402, 404 thereof, therefore translating any actuation of motion control arm 403 into a corresponding actuation of the ratio selection lever 306.

Device motion control arm 403 is further connected to a first motion control spring 406 extending between motion control arm 403 and a cable housing bracket 407. Cable housing bracket 407 houses at least one motion control cable (not shown), which operably links device motion control arm 403 to device speed control means 104 of user interface 102, the spring 406 providing a bias towards a position of device motion control arm 403 at which the transmission has a neutral ratio.

Device motion control arm 403 is further articulated to a motion control bracket 408 at a first end thereof. Motion control bracket 408 is substantially centrally pivoted by a second motion control pivot 409 mounted to another portion of the transmission casing 300. Motion control bracket 408 comprises a reversing stop bracket 410 at a second end thereof, which is connected to a second motion control spring 411 extending between motion control bracket 408 and the cable housing bracket 407. The articulation between motion control arm 403 and motion control bracket 408 is configured to restrict the travel of device motion control arm 403 when inputting a transmission ratio with device speed control means 104 of user interface 102, which is apt to effect reverse motion of the device, the spring 411 providing a bias towards a position of device motion control bracket 408 at which the transmission has a neutral ratio.

Thus, actuation of device speed control means 104, in the example a lever 104, imparts an amount of tension in at least one motion control cable, which is translated into a forward or reverse motion of motion control arm 403 relative to motion control pivot 405, any reverse motion of motion control arm 403 being subjected to the travel restriction afforded by motion control bracket 407, and which is translated into a corresponding compression or expansion of either of respective motion control springs 406, 411, as a function of whether the user wishes to displace the grass treatment device forwards, or backwards, or bring it to a stop. The motion of motion control arm 403 and, optionally, of motion control bracket 407 relative to their respective pivots 405, 409, result in a corresponding translation of motion control link 401, in turn imparting a corresponding motion to ratio selection lever 306 at which time the transmission ratio is changed, proportionally to the actuation input of lever 104.

With reference to FIG. 5, a first embodiment of the second linkage arrangement 114 is shown which is, in principle, substantially similar to first linkage arrangement 111. Ratio selection lever 307 is pivotally connected to a tool speed control link 501 at a first end 502 thereof, and a second end 504 of tool speed control link 501 is pivotally connected to a tool speed control arm 503.

Tool speed control arm 503 is pivoted by a motion control pivot 505 mounted to a portion of the transmission casing 300, proximal the end 504 at which it is pivotally connected to tool speed control link 501, whereby tool speed control arm 503 may pivot relative to rotation control pivot 505 independently of its pivotal connection to tool speed control link 501. This configuration permits a longitudinal displacement of tool speed control link 501, relative to the pivoted first and second ends 502, 504 thereof, therefore translating any actuation of tool speed arm 503 into a corresponding actuation of the ratio selection lever 307.

Tool speed control arm 503 is further connected to a tool speed control spring 506 extending between tool speed control arm 503 and a cable housing bracket 507. Cable housing bracket 507 houses at least one tool speed control cable (not shown), which operably links tool speed control arm 503 to tool speed control means 105 of user interface 102, the spring 506 providing a bias towards a position of tool speed control arm 503 at which the transmission has a neutral ratio.

Thus, actuation of tool speed control means 105, in the example a lever 105, imparts an amount of tension in the at least one tool speed control cable, which is translated into a forward or reverse motion of tool speed control arm 503 relative to tool speed control pivot 505, and which is translated into a corresponding compression or expansion of tool speed control spring 506, as a function of whether the user wishes to increase or decrease the rotation speed of the grass treatment tool in head 112, or bring it to a stop. The motion of tool speed control arm 503 relative to pivot 505 results in a corresponding translation of motion control link 401, in turn imparting a corresponding motion to ratio selection lever 307, at which time the transmission ratio is changed, proportionally to the actuation input of lever 105.

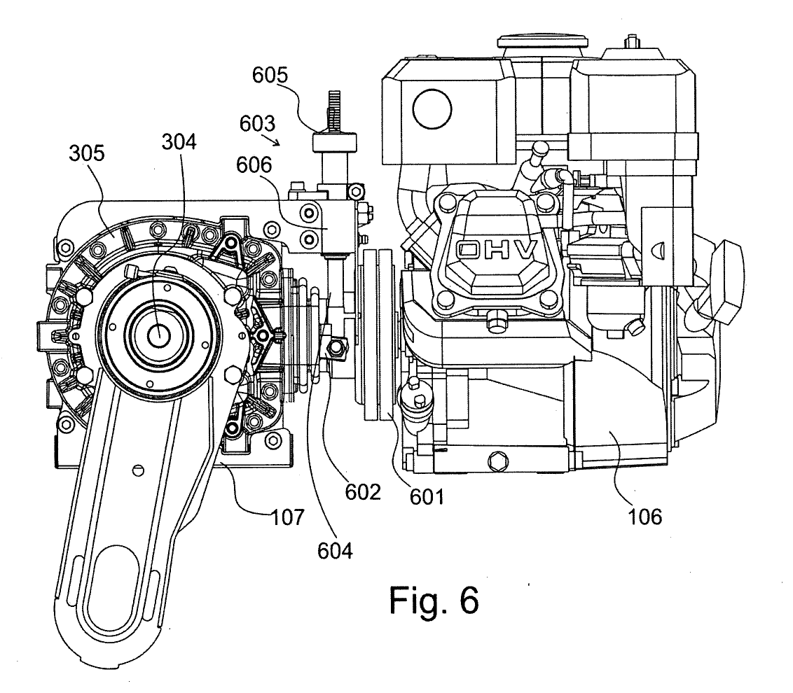

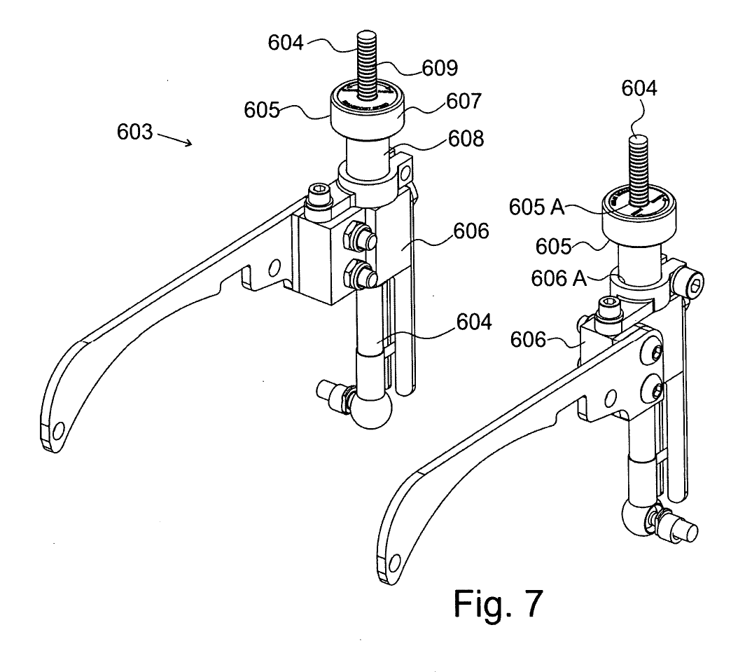

With reference to FIGS. 6 and 7, a further embodiment of the second linkage arrangement 114 is shown, which comprises substantially less components than the first embodiment and which is therefore advantageous in terms of cost and maintenance, relative to the first embodiment.

In this embodiment, the engine 106 is connected to the transmission 107 by a centrifugal clutch 601. The engine idle speed is preset to a certain number of revolutions per minute, in the example it is factory set to approximately 1400 rpm. The clutch 601 is likewise preset to engage the first input shaft 301 at a certain number of revolutions per minute, in the example it is adjusted to approximately 1700 rpm.

A cable (not shown) links the tool speed control means 105 to the throttle on the engine 106, wherein actuation of the tool speed control means 105 by the user increases or decreases the engine rpm, whereby the transmission engages or disengages the first input shaft 301 through the clutch, proportionally to the input by the user.

The output from the transmission is dependent on the position of a transmission adjusting lever 602. In the horizontal position, the transmission adjusting lever 602 is in “geared neutral”, wherein there is no output from the transmission at second output shaft 304, although the internals of the gearbox, described with reference to FIG. 3, i.e. the discs, rollers and shafts, are still rotating. A displacement of the transmission adjusting lever 602 upwards relative to the horizontal position proportionally increases the output from the gearbox at output shaft 304. A displacement of the transmission adjusting lever 602 downwards relative to the horizontal position proportionally reverses the output from the gearbox at output shaft 304.

Displacement of the transmission adjusting lever 602 is effected by a lever adjustment assembly 603, which comprises a transmission adjusting lever engaging shaft 604, a shaft height adjusting knob 605 and a shaft bracket 606 affixed to the transmission casing 300.

Transmission adjusting lever 602 is fixedly connected to the engaging shaft 604, and at least a portion of the outer surface of shaft 604 is threaded.

Shaft height adjusting knob 605 comprises a longitudinal through hole 605A having an inner surface, at least a portion of which comprises a thread suitable for engaging the thread of the outer surface of shaft 604. A first portion 607 of the outer surface of shaft height adjusting knob 605 has a first diameter and a second portion 608 of the outer surface of shaft height adjusting knob 605 has a second diameter larger than that of the first portion.

Shaft bracket 606 is located substantially above, and is substantially vertically relative to, the transmission adjusting lever 602, and is longitudinally coaxial with both the transmission adjusting lever engaging shaft 604 and the shaft height adjusting knob 605. Shaft bracket 606 comprises a through hole 606A having a diameter suitable for accommodating the first portion 607 of the outer surface of shaft height adjusting knob 605, and is configured to permit rotation of the shaft height adjusting knob 605 therein without any longitudinal translation relative to the bracket 606.

As shaft height adjusting knob 605 rotates about the shaft 604 engaged in its longitudinal through hole by way of their respective threads, and rotates coaxially with the through hole of bracket 606 without any longitudinal translation relative thereto along shaft 604, rotation of knob 605 therefore effects an upward or downward translation of the shaft 604 relative to the combination of the knob 605 and bracket 606. In the example, turning the adjusting knob 605 in the clockwise direction displaces the lever 602 in an upward manner and, reciprocally, turning the adjusting knob 605 in the counter-clockwise direction displaces the lever 602 in a downward manner. Advantageously, the second portion 608 of the outer surface of shaft height adjusting knob 605 may be knurled, to improve user interaction therewith.

In a specific embodiment, the portion 609 of shaft 604 which protrudes from the aperture in the adjusting knob 605 comprises graduation means, in the example indentations, which are visible to the user until such time as the downward translation of the shaft 604 relative to the combination of the knob 605 and bracket 606 within the knob through hole obscures them, therefore as a function of the number of revolutions by which the knob 605 is turned. The speed of the second output shaft 304 can therefore be correlated to the graduation means, in the example the amount of graduated marks which are visible.

It may be possible that errors are made when reading the graduations means, depending on the user's viewpoint. In a further specific embodiment, to reduce such errors, means are provided to allow a user to adjust the height of the shaft 604, and therefore the displacement of the transmission adjusting lever 602 relative to its neutral horizontal position, by predetermined quantized amounts only. Such adjusting means may comprise a ball detent, i.e. a spring-biased ball, and at least one complementary depression, which may be implemented at the rotatable connection between the shaft height adjusting knob 605 and the bracket 606.

For instance, at least one depression may be implemented in the outer surface of the first portion of knob 605, and a complementary ball detent mechanism may be implemented at a fixed position in the through hole of the bracket 606 accommodating the first portion 607 of knob 605, the ball detent mechanism having a longitudinal axis perpendicular to the longitudinal axis of the shaft 604, knob 605 and bracket 606.

Preferably, a plurality of depressions may be disposed radially about the outer surface of the first portion 607 of knob 605, and the ball of the ball detent is configured to releasably lock with each of the plurality of depressions, whereby when the user rotates the knob 605, a jolt is felt each time the ball in the bracket 606 releasably locks into a depression on the outer surface 607 of the knob 605. As and when the user is satisfied that the knob 605 has been sufficiently rotated to achieve the required tool speed, the ball releasably locks into place in a depression of the outer surface 607 of the knob 605. The strength of the biasing means is sufficient to keep the ball locked into the depression during normal use of the grass treatment device, and the ball can only be released from the depression by further rotation of the knob 605.

By careful selection of the outer radius of the outer shaft of knob 605, the number of depression and the pitch of the corresponding threads of the inner shaft 604 and threads of the inner wall of the knob 605, the distance of linear movement of the inner shaft 604 relative to the combination of knob 605 and bracket 606 can be related to the distance between depressions on the knob 605. By selecting a different diameter for the first portion 607 of the outer surface of knob 605, or a different pitch of threads, or a different number of depressions on the outer surface, the predetermined quantized amount can be altered.

With reference to the description of FIGS. 4 and 5, the first and second linkage arrangements, respectively for the first portion of the transmission dedicated to motion of the device and for the second portion of the transmission dedicated to powering of the device tool, are functionally equivalent. In the same manner, the principles described in relation to the further embodiment of the second linkage arrangement 114 in FIG. 6 are applicable to the first linkage arrangement 111. A first linkage arrangement 111 according to this further embodiment is substantially identical to the second linkage arrangement 114 described in FIG. 6, therefore as shown in FIG. 7, whereby again resulting in the capacity to change the respective transmission ratios for the device motion and the tool speed independently of one another, proportionally to user input.

1. A grass treatment device, comprising:
a motor configured to provide a power;
a grass treatment tool configured to interact with and treat a grass surface;
a drive mechanism configured to propel the device relative to the grass surface;
a transmission operably positioned between the motor, the tool and the drive mechanism, configured to transmit power from the motor independently to the tool and to the drive mechanism;
wherein the transmission is further configured to transform a constant output from the motor into independent variable powering of the tool and the drive mechanism.

2. A grass treatment device according to claim 1, wherein the drive mechanism configured to propel the treatment device and the grass treatment are powered by respective output shafts of the transmission.

3. A grass treatment device according to claim 2, wherein the output shafts respectively powering the drive mechanism and the grass treatment tool are driven with respective transmission ratios.

4. A grass treatment device according to claim 1, wherein the output shafts respectively powering the drive mechanism and the grass treatment tool are driven with the same transmission ratio.

5. A grass treatment device according to claim 1, wherein the transmission is capable of providing a continuously variable output.

6. A grass treatment device according to claim 5, wherein the transmission comprises a continuously variable transmission.

7. A grass treatment device according to claim 5, wherein the transmission comprises an infinitely variable transmission.

8. A grass treatment device according to claim 1, wherein the transmission is capable of powering either the grass treatment tool or the drive mechanism at a respective plurality of speed settings.

9. A grass treatment device according to claim 8, wherein the transmission comprises a speed selector mechanism.

10. A grass treatment device according to claim 1, wherein the transmission is capable of independently powering the grass treatment tool and the drive mechanism at a plurality of respective speed settings.

11. A grass treatment device according to claim 10, wherein the transmission comprises first and second speed selector mechanisms, wherein selection of a speed setting for the grass treatment tool is effected with the first speed selector mechanism and selection of a speed setting for the drive mechanism is effected with the second speed selector mechanism.

12. A grass treatment device according to claim 11, wherein each of the first and second speed selector mechanisms comprises a transmission adjusting lever, the displacement of which proportionally increases or decreases the transmission ratio.

13. A grass treatment device according to claim 12, wherein displacement of each transmission adjusting lever is effected by a lever adjustment assembly, comprising a transmission adjusting lever engaging shaft, a shaft height adjusting knob and a shaft bracket affixed to the transmission.

14. A grass treatment device according to claim 13, wherein a rotation of the shaft height adjusting knob effects either an upward or a downward translation of the transmission adjusting lever engaging shaft, relative to the combination of the knob and bracket.

15. A grass treatment device according to claim 13, wherein a portion of the transmission adjusting lever engaging shaft protrudes from an aperture in the adjusting knob and comprises graduation means, to which the speed of the transmission output shaft can be correlated.

16. A grass treatment device according to claim 12, further comprising means to adjust the height of the transmission adjusting lever engaging shaft by predetermined quantized amounts.

17. A grass treatment device according to claim 16, wherein the means to adjust the height of the transmission adjusting lever engaging shaft comprises a spring-biased ball and at least one complementary depression between the knob and the bracket.

18. A grass treatment device according to claim 17, further comprising a plurality of depressions.

19. A grass treatment device according to claim 1, wherein the grass treatment device comprises a cassette system configured to allow the introduction and removal of a plurality of various grass treatment tools, each of which is configured to be operably connected to the transmission.

20. A grass treatment device according to claim 19, wherein the grass treatment tool is one selected from the group comprising a vibratory roller; a thatchmaster; an ultra grooma; a scarifier; a sarel roller cassette;a star spiker;a rotary brush and a true level vibratory roller brush.

21. A grass treatment device according to claim 19, wherein the cassette system comprises a first and a second roller configured to contact a grass surface, wherein the treatment tool is positioned between the first and the second roller.

22. A grass treatment device according to claim 1, wherein the motor comprises an electrical motor.

23. A grass treatment device according to claim 1, wherein the motor comprises an internal combustion motor.

24. A grass treatment device according to claim 1, wherein the motor is connected to the transmission by a centrifugal clutch.

25. A grass treatment device, comprising:
a motor configured to provide a power;
a grass treatment tool configured to interact with and treat a grass surface;
a drive mechanism configured to propel the device relative to the grass surface;
a transmission operably positioned between the motor, the tool and the drive mechanism, configured to transmit power from the motor independently to the tool and to the drive mechanism;
wherein the transmission is further configured to transform a constant output from the motor into independent variable powering of the tool and the drive mechanism; and
wherein the grass treatment device is selected from the group comprising two-wheeled, four-wheeled and tracked devices

26. A grass treatment device according to claim 25, wherein the grass treatment device is selected from the group comprising devices requiring the user to stand in close proximity thereto, devices requiring the user to sit thereon and remote—controlled devices.

27. A transmission for use with a grass treatment device,
the device comprising
a motor configured to configured to provide power;
a grass treatment tool configured to interact with and treat a grass surface;
a drive mechanism configured to propel the device relative to the grass surface; and
the transmission;
wherein the transmission is operably positioned between the motor, the tool and the drive mechanism, and is configured to transmit power from the motor independently to the tool and to the drive mechanism; and
the transmission is further configured to transform a constant output from the motor into independent variable powering of the tool and the drive mechanism.

28. A transmission according to claim 27, wherein the drive mechanism configured to propel the treatment device and the grass treatment are powered by respective output shafts of the transmission.

29. A transmission according to claim 28, wherein the output shafts respectively powering the drive mechanism and the grass treatment tool are driven with respective transmission ratios.

30. A transmission according to claim 27, wherein the output shafts respectively powering the drive mechanism and the grass treatment tool are driven with the same transmission ratio.

31. A transmission according to claim 27, wherein the transmission is capable of providing a continuously variable output.

32. A transmission according to claim 31, wherein the transmission comprises a continuously variable transmission.

33. A transmission according to claim 31, wherein the transmission comprises an infinitely variable transmission.

34. A transmission according to claim 27, wherein the transmission is capable of powering either the grass treatment tool or the drive mechanism at a respective plurality of speed settings.

35. A transmission according to claim 34, wherein the transmission comprises a speed selector mechanism.

36. A transmission according to claim 27, wherein the transmission is capable of independently powering the grass treatment tool and the drive mechanism at a plurality of respective speed settings.

37. A transmission according to claim 36, wherein the transmission comprises first and second speed selector mechanisms, wherein selection of a speed setting for the grass treatment tool is effected with the first speed selector mechanism and selection of a speed setting for the drive mechanism is effected with the second speed selector mechanism.

38. A transmission according to claim 37, wherein each of the first and second speed selector mechanisms comprises a transmission adjusting lever, the displacement of which proportionally increases or decreases the transmission ratio.

39. A transmission according to claim 38, wherein displacement of each transmission adjusting lever is effected by a lever adjustment assembly, comprising a transmission adjusting lever engaging shaft, a shaft height adjusting knob and a shaft bracket affixed to the transmission.

40. A transmission according to claim 39, wherein a rotation of the shaft height adjusting knob effects either an upward or a downward translation of the transmission adjusting lever engaging shaft, relative to the combination of the knob and bracket.

41. A transmission according to claim 39, wherein a portion of the transmission adjusting lever engaging shaft protrudes from an aperture in the adjusting knob and comprises graduation means, to which the speed of the transmission output shaft can be correlated.

42. A transmission according to claim 38, further comprising means to adjust the height of the transmission adjusting lever engaging shaft by predetermined quantized amounts.

43. A transmission according to claim 42, wherein the means to adjust the height of the transmission adjusting lever engaging shaft comprises a spring-biased ball and at least one complementary depression between the knob and the bracket.

44. A kit of parts for a grass treatment device, comprising:
a motor configured to configured to provide power;
a grass treatment tool configured to interact with and treat a grass surface;
a drive mechanism configured to propel the device relative to the grass surface; and
a transmission operably positioned between the motor, the tool and the drive mechanism, configured to transmit power from the motor independently to the tool and to the drive mechanism;
wherein the transmission is further configured to transform a constant output from the motor into independent variable powering of the tool and the drive mechanism.

45. A method of independently powering a drive mechanism and a grass treatment tool of a grass treatment device, the method comprising the steps of:
providing the device with the grass treatment tool, the drive mechanism and a motor;
providing the device with a transmission operably positioned between the motor, the tool and the drive mechanism, wherein the transmission is configured to transform a constant output from the motor into independent variable powering of the tool and the drive mechanism; and
transmitting power from the motor independently to the tool and to the drive mechanism through the transmission.
